(19) United States
(12) Patent Application Publication
(10) Pub. No.: US 2022/0369581 A1
(43) Pub. Date: Nov. 24, 2022

(54) Multi-purposed solid state thermoelectric multi-stage root chamber and interface electromagnetically powered plant growing device

(71) Applicants: Joshua David Elliott, Chicago, IL (US); Alexander Christopher Elliott, chicago, IL (US)

(72) Inventors: Joshua David Elliott, Chicago, IL (US); Alexander Christopher Elliott, chicago, IL (US)

(21) Appl. No.: 17/739,113

(22) Filed: May 7, 2022

(51) Int. Cl. A01G 31/02

(52) U.S. Cl. CPC A01G 31/02; A01G 2031/006

(57) ABSTRACT

A wireless powered solid state thermoelectric operated, multi staged, multi interfaced, soilless plant growth system consisting of a plurality of plates defining a plurality of orifices, channels, and chambers formed by connecting a series of engraved plates within the body of the plant growing device. Consisting of a computer controller, sensors, LED, pumps, and fan(s).

### BACKGROUND OF INVENTION

Most plant root systems require four main inputs for healthy growth: air, water, nutrients, and light. As long as these inputs are adequately provided to the plant, the root system does not need to be placed in soil to thrive. The growing of plants in a nutrient rich, oxygenated, water based solution is known as hydroponics. The growing of plants in a nutrient rich air mist environment is known as aeroponics.

Such physical soilless systems typically house the plant and provide its roots with a nutrient water based solution and air consisting mainly of nitrogen, oxygen, carbon dioxide, neon, and hydrogen. An advantage of such systems is the ability to have greater control over pathogens and other microorganisms to encourage symbiosis or neutrality. Such systems can provide great flexibility over location of plant growth, either in terms of indoor versus outdoor, smaller quarters, and/or places with unusable soil.

A system using a nutrient solution in a fluid stage can be better controlled to balance nutrients, oxygen, and other conditions, such that improved growth characteristics can be obtained compared to soil-grown plants. With soilless methods, dense and fine root structures can be developed by the plant, thereby optimizing and facilitating transport through the xylem.

Moreover, the addition of adequate oxygen to a nutrient solution or the use of aerosol prevents the respiratory death of cells in the root and prevents root rot, pathogenesis, by maintaining a healthy root immune system.

Plants are pruned in order to promote growth, an aeroponic system is able to dry root ends causing root pruning increasing root growth rate.

A primary concern with commercial and domestic plant growth devices are in the transportation of the food from farm to store and/or store to consumer. The transportation of the plant itself becomes time sensitive once harvested, and any unused or unsold, is wasted creating greenhouse emissions.

A primary concern is the wear and tear in transporting the growing device, having to unplug and disconnect multiple wires will lead to the connectors wearing out and the need for more workers or higher complexity in robotics during transportation.

A primary concern is the wasted energy when using a thermoelectric module to cool. As power is applied to the module the cold side removes heat and disperse it to the opposite side of the solid state thermoelectric module. The energy used is split in half, half to the hot side and half to the cold side. However, the heat removed from the cold side is also pushed to the hot side in conjunction with the heat already created when powered on the hot side. This grossly undervalues the efficiency of the thermoelectric unit if wasted.

A primary concern is the wasted cold air from the cold side of a thermoelectric unit when using the cold side with a cold sink used as a dehumidifier or atmospheric water generator. As the humid air is condensed on the cold sink and water droplets are formed, but the cold dry air is dispersed and unused.

A primary concern is the wasted ability to dehumidify by atmospheric water generation while using the solid state thermoelectric to cool the air.

A primary concern is the filters, pumps, air pumps, deep cycle machines, cooling mechanisms, valves, accumulators, relays that make noise when in operation. The components that have moving parts are susceptible to breakdown when considering the harsh environment from the sodium found within the nutrients. Nozzles clog from the build up of sodium from the nutrients which are used in aeroponic systems. Furthermore most systems require hoses and clamps with multiple possible leak points which can cause crop failure if the nutrients and or water begin to leak.

A primary concern is the manufacturing of such a complex device. Most aeroponic and hydroponic systems require hand assembly for hose, barbs, clamps and chamber/reservoir connections creating a more costly unit to assemble and requiring more parts.

A primary concern is adapting methods which best suit the plant in its various stages of growth. For example: an aeroponic method is more advantageous when the plant is in a vegetative stage, but when in a blooming stage and/or flowering stage a hydroponics method is more advantageous. Seedling stage used with a hydroponic method has best results. Constant observation and the moving of plants into different environments require more work.

A primary concern is the water wasted used during plant growth. Approximately 80% of water used in plant growth is transpired and evaporated.

A primary concern is lack of root pruning methods causing too much or too little of the root to dry out and die

### OBJECT OF THE INVENTION

It is therefore an object of the present invention to solve the aforementioned problems and to provide a growing device that can be assembled by the stacking of plates and fastening.

Allowing high quantities to be built with minimal tooling of factories with high volume specifically in the field of injection molding lowering the cost of mass production considerably.

A further objective of the invention is to optimize the water/root interface at various stages in a plant's life, increasing transpiration of leaves for rapid growth. And recapturing the water transpired by the plant for the purpose of water conservation.

A further objective of the invention is to use the benefits of thermoelectric technology in creating hot and cold with no moving parts without wasting energy, and to capture the excess heat energy to power the growing devices electronics.

A further objective of the invention is to power it wirelessly to be used in transporting.

A further objective of the invention is to keep the plant alive during the transportation and selling stages until the plant is needed for food, removing the need for costly storage fees and preventing the waste of unused food.

A further objective of the invention is to be self cleaning with no filters.

A further objective of the invention is to provide itself with water as an atmospheric water generator and self dosing in nutrients to lower or remove the need for maintenance.

A further objective of the invention is to have the ability to function with no moving parts.

A further objective of the invention is to provide greater control over root pruning, by adjusting air directly vented in various locations by air volume, speed, and humidity settings

### BRIEF SUMMARY OF THE INVENTION

The aforementioned problems and needs are addressed in this plant growing device that includes multiple plates engraved with chambers, channels, cavities and orifices. Having an orifice through which a plant stalk can extend upward. An upper root chamber that has an upper level for seedlings' roots to reach the water and nutrients in a hydroponic interface. A nutrient chamber for the nutrient solution and water to be premixed. A middle root chamber where roots are met with distribution of hot and cold air and have water and nutrient interface in an aeroponic method. A lower root chamber where mixed nutrient and water solution is stored and warmed for larger blooming/flowering plants to be supplied in a hydroponic interface.

A separate heat chamber in fluid contact with a solid state thermoelectric module's hot side by connection to the heat plate, where water can be heated and configured to receive liquid nutrient solution from the lower root chamber through a drain channel, to vaporize the received liquid nutrient solution, and to supply the vapor through a vapor channel to a water collecting chamber to create a first pressure in the heat chamber that is greater than a second pressure located in the water collecting chamber causing the nutrients to remain in the heated chamber purifying the water by distillation and burning off any disease, pathogens, zeroing out the ph and ppm levels in the water to be remixed with a nutrient solution in the nutrient chamber. The remaining water stored in the water collector chamber provides fresh water to the user and assists in cooling of the vapor.

A light is located under the air collecting chamber. The air collecting chamber collects water saturated air transpired by the plant leaf pulled through a series of orifices in the air collector through channels into the air collecting chamber by a fan(s) that cools the light's heat sink and pushes the air into tubes into both the heat plate/cold plate and the front plate/root plate which leads to the cooling chamber from the front plate/root plate channel. The cold side of the solid state thermoelectric module which is connected to a cold sink/plate condenses the water in the air into water droplets which is pumped into the water catching chamber and used to cool down the heated vapor previously mentioned then drained into nutrient chamber then into upper root chamber them middle root chamber then lower root chamber. The cold air is used to cool the electronics of the growing device and pushed into the middle root chamber through a series of channels that lead to air vents. The warmer air is pushed out of the middle root chamber into a section of the water collector and exhausted near and above the neoprene disc out of plant stalk orifice to begin an upward draft to be collected by the air collector. A separate portion of air is pushed by fan(s) into the heat/cold plate channels to help control heat from a solid state thermoelectric module, the air is then exhausted at the lower portion of the device out of the heat plate to begin an upward ambient draft back to the air collector.

The plant growing system consists of four vertical plates attached to one upper horizontal plate which is separated by an open area connected by tubes in parallel fashion to a higher plate by tubes.

A bottom cover holds an electromagnetic receiving device and protects it from damage. Middle cover is used for the water collector and a top cover is used for the air collector.

Other objects and features of the present invention will become apparent by a review of the specification, claims and appended figures.

### BRIEF DESCRIPTION OF FIGURES

FIG. 1 is a schematic view of the plant growing device of the present invention.

FIG. 2 is a front view of the growing device of the present invention.

FIG. 3 is a right side view of the growing device of the present invention.

FIG. 4 is a rear side view of the growing device of the present invention.

FIG. 5 is a left side view of the growing device of the present invention.

FIG. 6 is a top view with the bottom cover on the right side and top of present invention in center and bottom cover on right island middle cover below on the side of it of the growing device of the present invention.

FIG. 7 is a bottom view with the bottom cover on the left side and top cover on the right and middle cover below it of the growing device of the present invention.

FIG. 8 is a perspective view of the front and left side top view of the growing device of the present invention.

FIG. 9 is a perspective view of the rear and right side bottom view of the growing device of the present invention.

FIG. 10 is a cross section left side view of the growing device of the present invention.

FIG. 11 is a cross section right side view of the growing device of the present invention.

FIG. 12 is a front view of the front plate of the growing device of the present invention.

FIG. 13 is a rear view of the front plate of the growing device of the present invention.

FIG. 14 is a left side view of the front plate of the growing device of the present invention.

FIG. 15 is a right side view of the front plate of the growing device of the present invention.

FIG. 16 is a perspective view of the bottom left of the front plate of the growing device of the present invention.

FIG. 17 is a top view of the front plate of the growing device of the present invention.

FIG. 18 is a bottom view of the front plate of the growing device of the present invention.

FIG. 19 is a front view of the root plate of the growing device of the present invention.

FIG. 20 is a rear view of the root plate of the growing device of the present invention.

FIG. 21 is a left side view of the root plate of the growing device of the present invention.

FIG. 22 is a right side view of the root plate of the growing device of the present invention.

FIG. 23 is a perspective view of the top left of the root plate of the growing device of the present invention.

FIG. 24 is a top view of the root plate of the growing device of the present invention.

FIG. 25 is a bottom view of the root plate of the growing device of the present invention.

FIG. 26 is a front view of the cold plate of the growing device of the present invention.

FIG. 27 is a rear view of the cold plate of the growing device of the present invention.

FIG. 28 is a left side view of the cold plate of the growing device of the present invention.

FIG. 29 is a right side view of the cold plate of the growing device of the present invention.

FIG. 30 is a top front perspective view of the cold plate of the growing device of the invention.

FIG. 31 is a top view of the cold plate of the growing device of the present invention.

FIG. 32 is a bottom view of the cold plate of the growing device in the present invention.

FIG. 33 is a front view of the heat plate of the growing device of the present invention.

FIG. 34 is a rear view of the heat plate of the growing device of the present invention.

FIG. 35 is a left view of the heat plate of the growing device of the present invention

FIG. 36 is a right view of the heat plate of the growing device of the present invention.

FIG. 37 is a top front perspective view of the heat plate of the growing device of the present invention.

FIG. 38 is a top view of the heat plate of the growing device of the present invention.

FIG. 39 is a bottom view of the heat plate of the growing device of the present invention.

FIG. 40 is a front view of the water collector of the growing device of the present invention.

FIG. 41 is a rear view of the water collector of the growing device of the present invention.

FIG. 42 is a left view of the water collector of the growing device of the present invention.

FIG. 43 is a right view of the water collector of the growing device of the present invention.

FIG. 44 is a top perspective view of the water collector of the growing device of the present invention.

FIG. 45 is a top view of the water collector of the growing device of the present invention.

FIG. 46 is a bottom view of the water collector of the growing device of the present invention.

FIG. 47 is a front view of the air collector of the growing device of the present invention.

FIG. 48 is a rear view of the air collector of the growing device of the present invention.

FIG. 49 is a left side view of the air collector of the growing device of the present invention.

FIG. 50 is a right side view of the air collector of the growing device of the present invention.

FIG. 51 is a top perspective view of the air collector of the growing device of the present invention.

FIG. 52 is a top view of the air collector of the growing device of the present invention

FIG. 53 is a bottom view of the air collector of the growing device of the present invention

### DETAILED DESCRIPTION OF THE INVENTION

Heat conductive and non conductive material can be used as plates, preferably the heat plate should be made by a heat conductive material but not limited to. Preferably the cold plate should be made of non conductive material. Preferably the root plate should be made of non conductive material. Preferably the front plate should be made of non conductive material. A wood based material can be used for the root plate and front plate to add flavor.

It is made up of any food safe material such as hdpe, acrylic, stainless steel, clay, anodized aluminum or wood but not limited to. A growth medium can be used preferably a neoprene disc but not limited to. For example, clay pellets can be used. The device consists of a plurality of prefabricated parts; a light (preferably LED but not limited to), solid state thermoelectric module, wires, fans, tubes, wireless powering receivers, optional heat-sinks, cold-sinks, printed circuit boards, temperature sensors, level sensors, humidity sensors, and pressure sensors. Optional pumps, power supply units, batteries, wireless communication components, microprocessors, and analog devices are held captive in one or more chambers and channels. Optional water sealing substance is pressed between the plates. Optional fasteners hold the series of plates together.

Water, nutrients, and air are heated, cooled, purified, condensed, mixed, and vaporized through the plurality of channels, orifices, and chambers formed between the plates in order to provide an optimal growing environment for the plant.

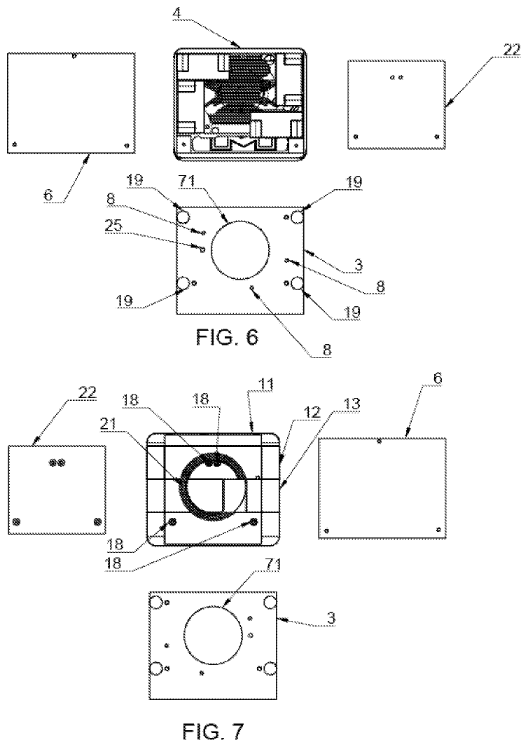

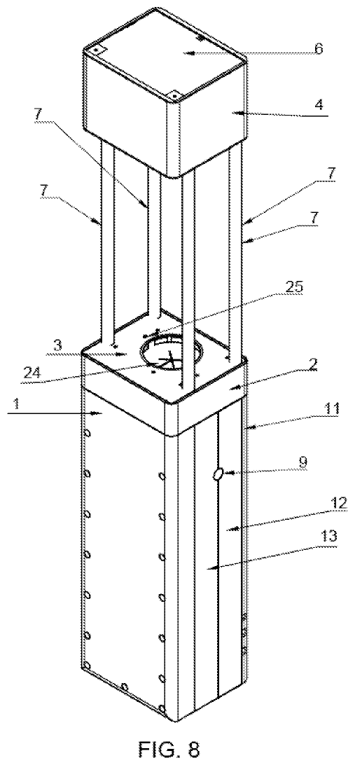

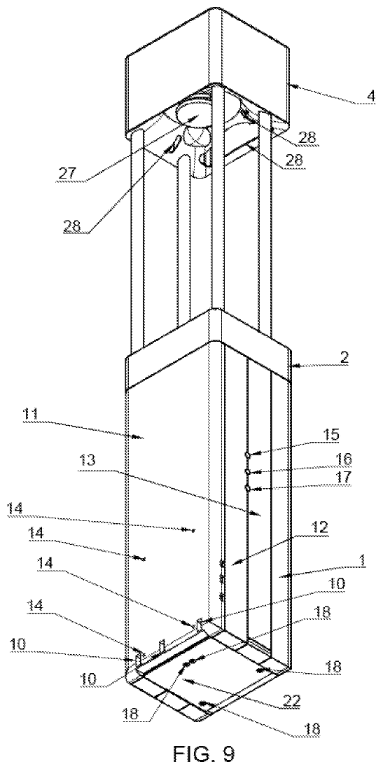

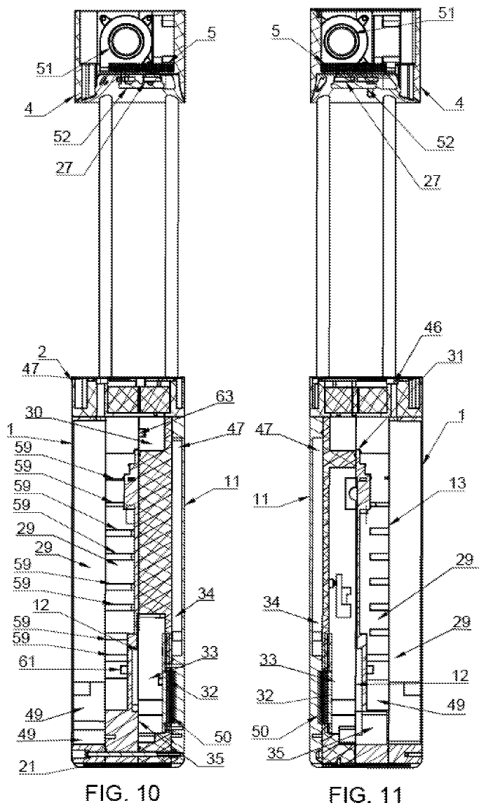

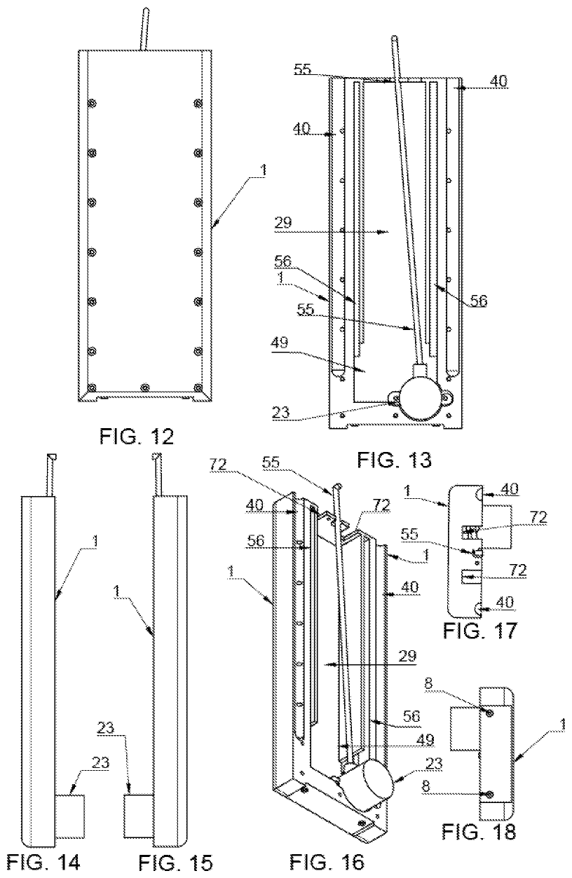

The plant is supported and held in the main cavity 39 located in the water collector plate 2 (see FIG. 44). Portions of the plant are divided by a grow medium 24 held within the cavity of the plate (see FIG. 45). The grow medium can be a neoprene disc which has a small expandable hole where the seed is planted and remains in the germination state. The plant extends upward through the main orifice 71 of the middle cover (see FIG. 6). The roots are held and supported by the upper root chamber 30 (see FIG. 10) located in the top portion 30 of the cold plate 12 (see FIG. 10) and root plate 13 (see FIG. 11). Nutrients and water are puddled by a micro bulkhead 31 (see FIG. 11) to assist the plant in a seedling state. A middle root chamber 29 is located between the root plate 13 (see FIG. 11) and front plate 1 (see FIG. 11). The root plate middle root chamber 29 (see FIG. 11) has engraved distribution blocks 73 (see FIG. 23) that divide the water, nutrients, and roots evenly horizontally to ensure proper coverage with minimal water flow. The water poured down is deflected by the distribution blocks away from the root plate causing a mist while falling, watering the middle root section with an aeroponic interface with a focus on vegetative and pre-flowering state. A lower root chamber 49 (see FIG. 11) contains a pool of warmer solution and is specifically designed to compensate for the plants changing needs as it develops into a flowering/blooming state and is fed water and nutrients in a hydroponic interface with a focus on the harvesting state.

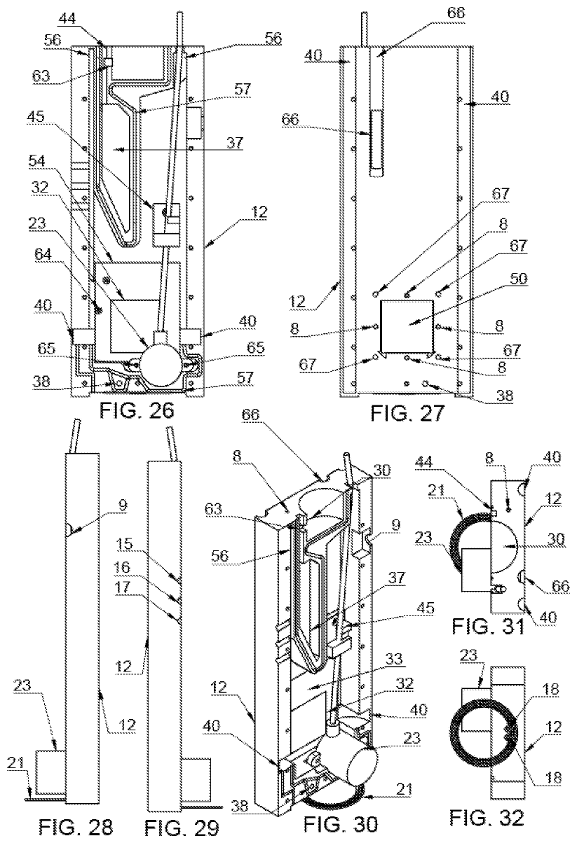

A nutrient chamber 37 is located between (see FIG. 26) the cold plate 12 and root plate 13 see FIG. 11). It holds a water based nutrient solution. An orifice 25 (see FIG. 6) located in the middle cover 3 is used to resupply the concentrated nutrients by the user. As a non limiting example, the nutrient solution can include the following (per gallon of water base) 6.0 gram of Ca(NO3)2, 2.09 grams KNO3, 0.46 grams K2SO4, 1.39 grams KH2PO4, 2.42 grams MgSO4 7H2O, and 0.4 grams of 7% Fe Chelated trace elements (where Fe Chelated trace elements can include 7% iron, 2% manganese, 0.4% zinc, 0.1% copper, 1.3% boron and 0.06% molybdenum. Water mixed with nutrients is from here on referred to as a solution.

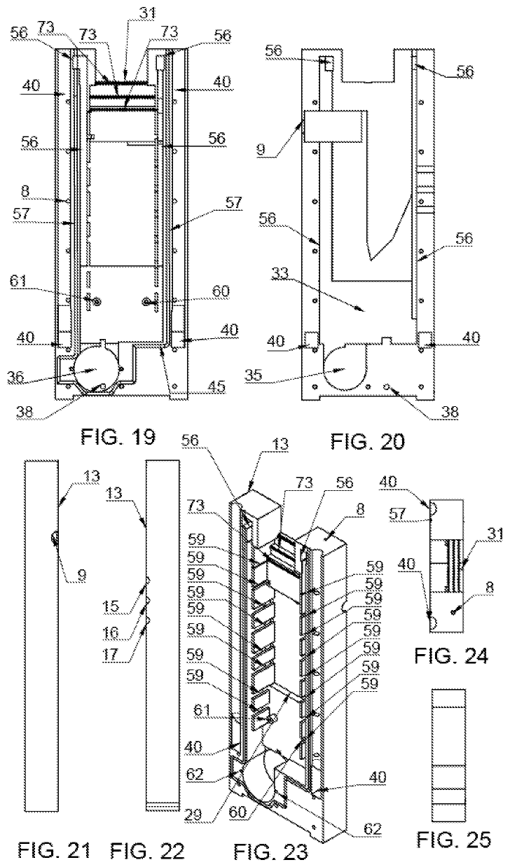

A solid state thermoelectric module 50 from here out known as TEC (see FIG. 10 and FIG. 11) is mounted flush 68 on heat plate (see FIG. 37) and used to heat the water and nutrient solution in the heat chamber 34 (see FIG. 33) located between the heat plate 11 and cold plate 12 (see FIG. 11) fed through the solution drain channel 38 (see FIG. 37, FIG. 26, FIG. 19) increasing molecular movement and evaporated through the vapor channel 66 (see FIG. 30, FIG. 37, FIG. 45) into the lower water catching chamber 2 (see FIG. 44) located above front, root, cold, heat plates where it is condensed by water held in the chamber purifying the water by a distillation process and zeroing out the PH and PPM levels. The distilled water is drained through a distilled water drain channel 69 (see FIG. 44 and FIG. 45) into the nutrient chamber 37 (see FIG. 26) through the distilled water and nutrients resupply channel 44 (see FIG. 26) which is then overfilled and overflows into the upper root chamber through a drain channel 63 (see FIG. 30) into a puddle in the upper root chamber 30 (see FIG. 30), then poured into the middle root chamber then pooled into the lower root chamber which is in fluid connectivity through a drain channel into the heat chamber cycled again by the heat side of the TEC. The solution is able to drain through the drain channel 38 (see FIG. 20) into the heat chamber or circulated by a solution pump 23 (see FIG. 13) from the lower root chamber through a solution channel 48 (see FIG. 44) into the plant stalk cavity 39 (see FIG. 44) above the grow medium 24 (see FIG. 45) and drained down into the nutrient drain orifices 38 (see FIG. 45) into the upper root zone then puddled, poured, and pooled again for recirculating purposes.

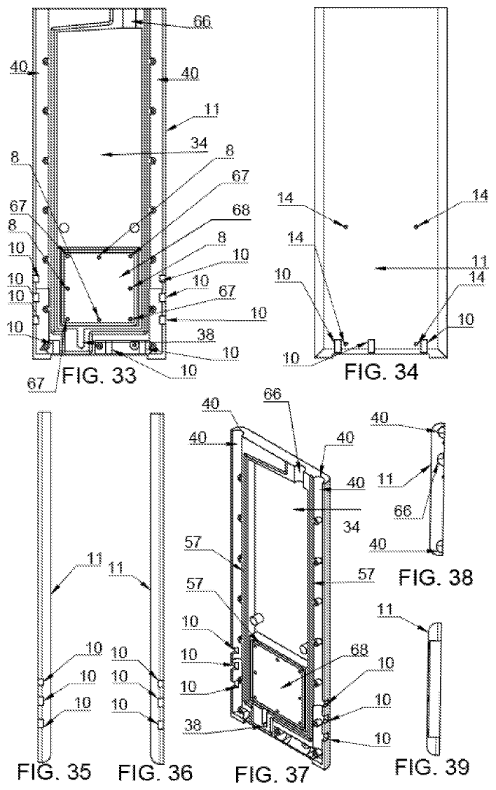

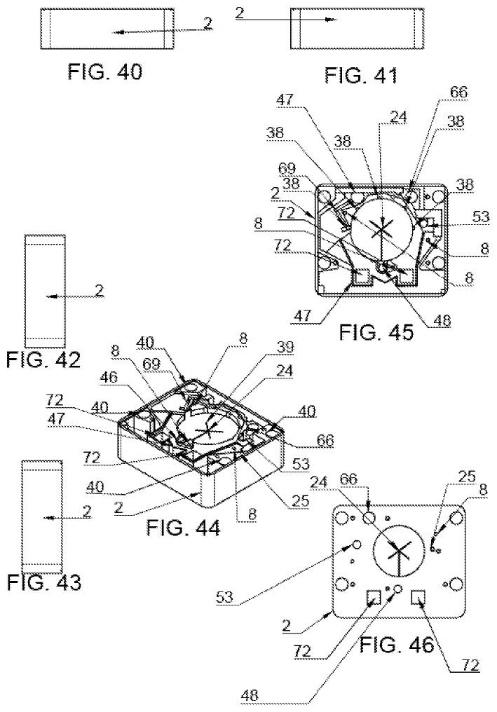

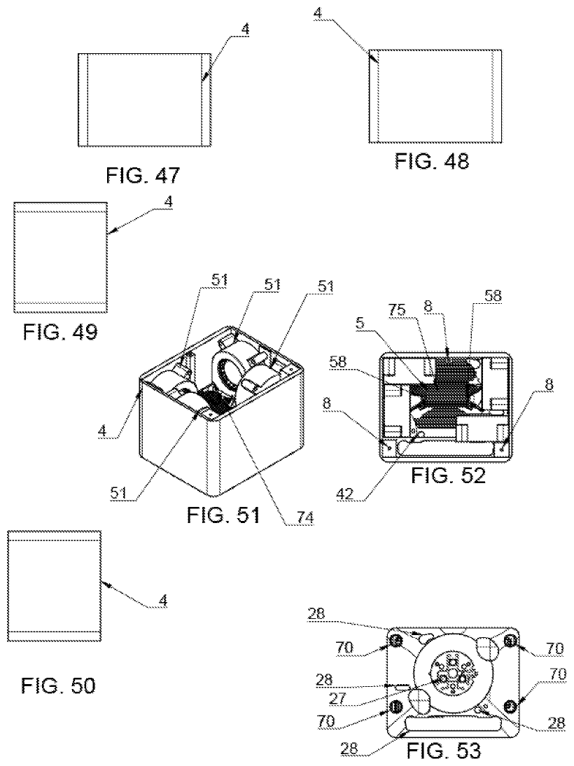

The growing device collects the water saturated air transpired by the plant from the leaves and from the exhaust vents 72 (see FIG. 44) found in the water collector plate, and exhaust vents 10 (See FIG. 33) found in heat plate, into the air collector orifices 28 (See FIG. 53) located in air collector plate 4 (see FIG. 51) into the air collecting chamber 74 (see FIG. 51). A fan(s) 51 (see FIG. 51), approximately 40 mm×40 mm with a cfm of 3.7 and static pressure of 0.87, are fastened in the air collector chamber. The water saturated air is pulled past through the air distribution channels 75 (see FIG. 52) which are also engraved heat sink 5 (see FIG. 52). A grow light 27 (see FIG. 53) is attached underneath, preferably LED and preferably cxb 3070 at 36 v and 700 milliamps with a spectrum of 3500 k but not limited to. A portion of air is pushed by the fan through the tubes directed into a series of push air channels 40 (see FIG. 19) through the front plate 40 (see FIG. 13) and root plate 40 (see FIG. 19) into the cold chamber 33 (see FIG. 30) 33 (see FIG. 30) 33 (see FIG. 10) located between the cold plate and root plate. The cold sink 32 (see FIG. 30) is simultaneously cooled by the opposing side of the TEC of the heat plate. The water saturated in the air supplied by the plant transpiration is condensed on the cold sink fins attached to the TEC. The cooled fresh water created by condensation is pumped 23 (see FIG. 26) through the pumped cooled condensed water channel 53 (see FIG. 45) 53 (see FIG. 44) into the water collector chamber 47 (see FIG. 44) 47 (see FIG. 45) in order to assist in cooling the heated vapor previously discussed. The cooled dry air remaining in the cold chamber is then pushed through upper channels 56 (see FIG. 20) into the root plate and down cool dry air channels 56 (see FIG. 23) located on the sides of the middle root zone exhausted through vents 59 (see FIG. 23) into the middle root chamber directed at the root(s) at various temperatures, volume, and pressure based on the fan settings determined by the computer controller 45 (see FIG. 30). The air located in the middle root zone that is warm continues to flow upward by convection through the exhaust orifices 72 (see FIG. 46) located in the water collector plate and exhausted in the area of the stalk cavity drying the plant leaves pushing the air back in an upward motion into air collector orifices. A separate portion of the air is pushed by the fan through the tubes 7 (see FIG. 11) into channels 40 located between heat plate and cold plate (see FIG. 33 and FIG. 27) to assist with cooling of the heat plate which is simultaneously a heat sink for the hot side of the thermoelectric module and is exhaust the air 10 (see FIG. 33) at the lower levels of the heat plate in order to begin an upward motion by convection into the air collector orifices. Optional mounting holes 14 (see FIG. 34) can be found on the heat plate to assist with cooling and additional heat transfer units.

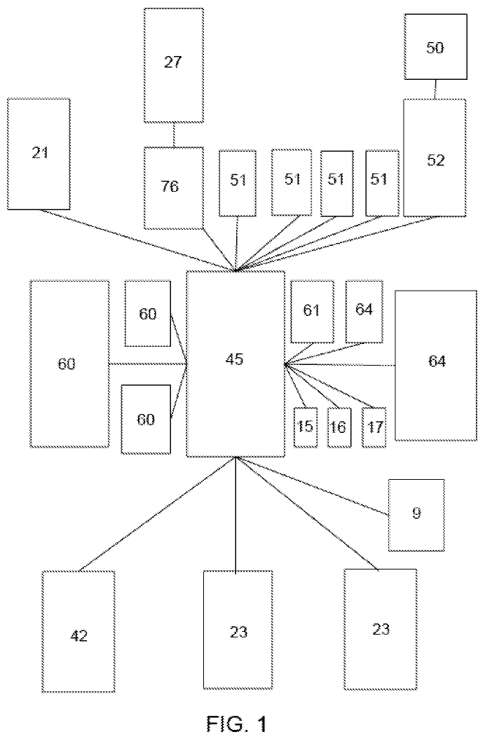

A controller containing control circuitry 45 (see FIG. 1) is connected to the various system components for monitoring and control. Sensors are shown where the controller receives the outputs of temperature for both TEC and root zone 60 (see FIG. 19) etc., water level sensor 61 (see FIG. 19), and wireless charging receiver coil 21 (see FIG. 30). The controller operates both pumps, the heating unit, the light, and the fan(s). In order to achieve optimal, air pressure, air temperature, air flow, and achieve optimal water temperature and water flow. A root temperature of 67 F to 73 F is optimal for most plants.

It is important to note the growing device can function without a controller and sensor(s).

### SUMMARY OF INVENTION

The present invention has many advantages. The system provides pressure enhanced fusing of water, nutrients and air into roots greatly increasing plant growth rates and allowing crop harvest in shorter growing cycles by increasing the pressure of the fan(s).

The system and method of the present invention provides a platform for rapid crop growth with a small form factor, allowing for indoor use in otherwise harsh climates. The system can be used in all seasons and in locations closer to the consumer (reducing shipping costs and time, and allowing produce to be grown locally and consumed). The system, by distillation, is self cleaning, and can be used with no pumps, making it silent.

It has been discovered that a drying of roots at specified locations at specified times can increase plant growth. The cool dry air is directed horizontally to the root zones changing the temperature of the root zones warmer to cooler then warmer multiple times approximately 5 mm segments but not limited to in an oscillating fashion scaling up the root area in order to increase osmosis and root pruning.

The present invention is useful to optimize energy used for growth by using the same fan(s) for both cooling LED and cooling air and directing air to a cold sink used as an atmospheric water generator and cooling heat plate used as a heat sink for the hot side of the TEC.

The present invention's convection balance allows it to receive and handle a wide range of energy. It can run on less than 1 watt and greater than 200 watts but is not limited to. The more heat it creates the more cold it creates to balance the plants environment providing the ideal environment for the plant. This allows the device to be used in either hot or cold environments.

The present invention is able to optimize energy by using both the heat generating side of the TEC to move water in an upward fashion as steam, to use the steam in a distillation process to purify and filter the water, simultaneously using the opposite cooling side of thermoelectric module to generate water and dry the air for rapid root pruning and cooling of the middle root zone.

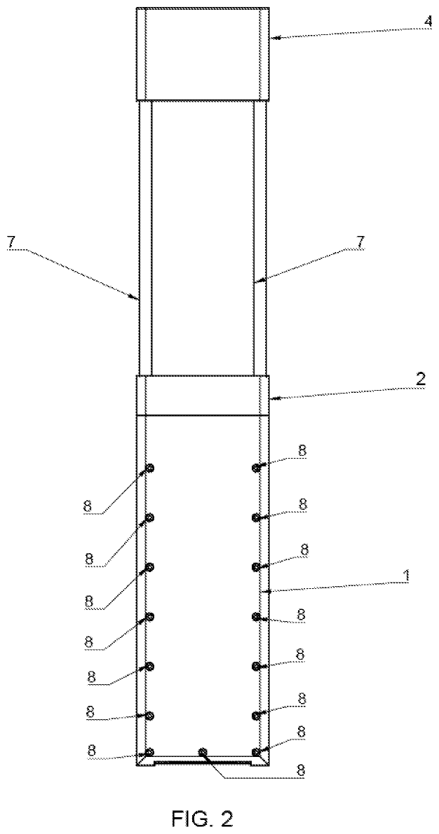

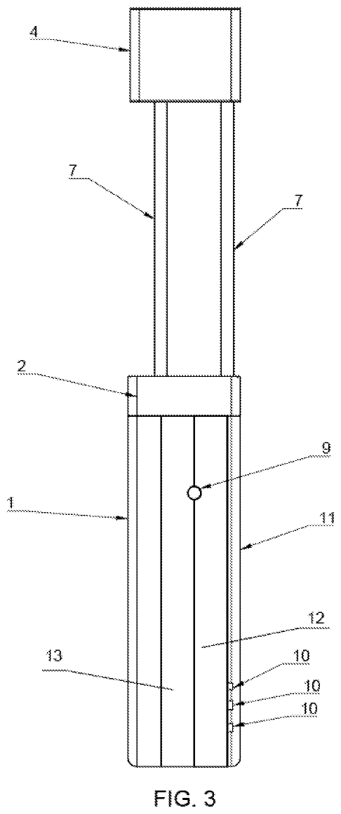

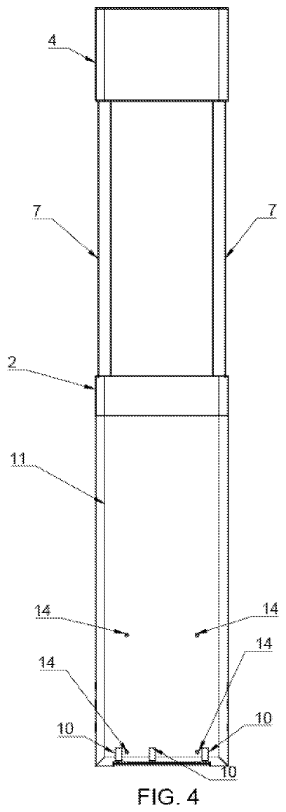

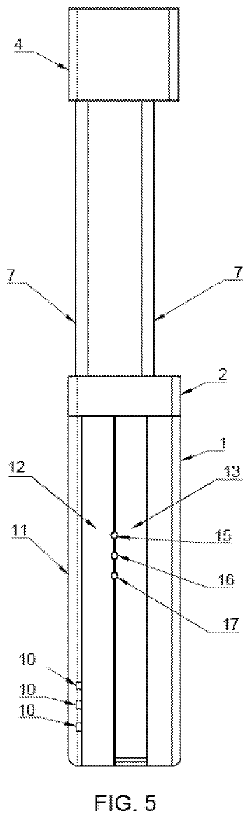

The present invention is manufactured using plates with engraved chambers, channels, cavities, and orifices in order to increase efficiency in the manufacturing process allowing for a more efficient assembly of a growing device. The plates can simply be fastened together 8 (see FIG. 2) with no need for hoses and clamps if the user chooses.

It is to be understood that the present invention is not limited to the embodiment(s) described above and illustrated herein, but encompasses any and all variations falling within the scope of any claims. For example, references to the present invention herein are not intended to limit the scope of any claim or claim term, but instead merely make reference to one or more features that may be covered by one or more of the claims. Materials and numerical examples described above are exemplary only, and should not be deemed to limit the claims.

### DRW

### DRAWINGS

### APPENDIX

1 Front Plate
2 water collector
3 Middle cover
4 Air collector
5 LED heat sink
6 Top cover
7 Tubes
8 fastener channels
9 Lower Wire(s) connector
10 Exhaust vents
11 Heat plate
12 Cold plate
13 Root plate
14 optional external cooler mounting holes
15 LED on
16 LED water level
17 LED nutrient level
18 Bottom cover mounting holes
19 Air inlet for Heat plate
20 Air inlet for Cold plate
21 Magnetic electric coil receiver
22 bottom cover
23 water pump
24 growth medium
25 nutrient inlet orifice
26 plant stalk orifice
27 LED grow light
28 air collector intake orifices
29 middle root chamber
30 upper root chamber
31 micro bulkhead
32 cold sink
33 cold chamber
34 heat chamber
35 fresh water pump cavity
36 nutrient solution pump cavity
37 nutrient chamber
38 solution drain channel
39 plant stalk cavity
40 air push channel
41 air pull channel
42 upper wire(s) connector
43 air pulled channel
44 nutrient channel
45 computer controller
46 pumped solution channel
47 water collecting chamber
48 pumped solution channel
49 lower root chamber
50 thermoelectric module TEC
51 Fan
52 LED grow reflector housing
53 cooled condensed water orifice
54 insulator
55 solution channel
56 pre cooled dry air channel
57 sealant channel
58 LED mounting holes
59 pre cooled dry air vents
60 temperature/humidity sensor
61 water level sensor
62 solution pump mounting holes
63 Premix nutrients and distilled water overflow channel
64 TEC temperature sensor
65 fresh water pump mounting holes
66 heated vapor channel
67 cold sink mounting holes
68 TEC hot side mounting plate
69 purified water channel
70 Air push orifices
71 plant stalk orifice
72 root chamber exhausted air channel
73 distribution blocks
74 air collecting chamber
75 air distribution channels
76 LED driver

What is claimed is:

1. A plant growing device comprising: a plurality of plates having a plurality of orifices, channels, cavities, and chambers

2. The plant growing device of claim 1, wherein the thermoelectric solid module is configured to vaporize a liquid solution to create a first pressure inside the chamber that is greater than a second chamber immediately outside the first chamber for water movement

3. The plant growing device of claim 2, wherein the thermoelectric solid state module is configured to simultaneously cool air by abstracting the heat from the air and use the air to cool and pressurize the root zones

4. The plant growing device of claim 3, wherein the thermoelectric solid state module is configured to simultaneously abstract water from humid air transpired by or around the plant condensing atmospheric water vapor using a cold sink as a dehumidifier

5. The plant growing device of claim 4, using a microcontroller to reverse the electrical flow of the thermoelectric solid state module transferring heat into electricity for the use of the plant growing device's electronics

6. The plant growing device of claim 1 further comprising a magnetic loop receiving antenna (copper coil) used to receive an oscillating magnetic field resonated inductive charging or magnetic resonance as power to the plant growing device's electronics

7. A method of growing plants, comprising: a chamber having a plurality of sub chambers providing plant(s) each having a stalk extending through one of the holes, wherein each of the plant(s) has roots disposed inside of the chamber and leaves disposed outside the chamber, providing nutrients and water with various interfaces in each sub chamber

8. The method of claim 7 further comprising of an upper root zone for water and nutrients interfaced with plant(s) roots by shallow water depth approximately 0.5 mm in a hydroponic interface to increase plant growth in seedling stage and increase humidity

9. The method of claim 8 further comprising of a middle root zone for water and nutrients interfaced with plant(s) roots by open air aeroponic method to increase plant growth in vegetative stage

10. The method of claim 9 further comprising of air vents exhausting cooler dried air interfaced with plant(s) roots in specific locations with variable humidity, velocity, and volume conditions to increase controlled root pruning efficiency

11. The method of claim 7 further comprising of air vents exhausting cooler dried air interfaced with plant(s) roots in specific locations with variable humidity, velocity, and volume conditions to increase controlled root pruning efficiency

12. The method of claim 10 further comprising of a lower root zone for water and nutrients interfaced with plant(s) roots by deep cycle hydroponic method to increase produce in plant bloom stage

13. The method of claim 7 further comprising of a lower root zone for water and nutrients interfaced with plant(s) roots by deep cycle hydroponic method to increase produce in plant bloom stage

14. The plant growing device of claim 1 further comprised of all components engraved in plates

15. The plant growing device of claim 2, wherein the thermoelectric solid module is configured to vaporize a liquid solution to create a first pressure inside the chamber that is greater than a second chamber immediately outside the first chamber for water purification purposes
